(19) United States
(12) Patent Application Publication
(10) Pub. No.: US 2014/0043338 A1
(43) Pub. Date: Feb. 13, 2014

(54) WAVEFORM DISPLAY APPARATUS

(71) Applicant: YOKOGAWA ELECTRIC CORPORATION, Tokyo (JP)

(72) Inventors: Yuya IKETSUKI, Tokyo (JP); Takeshi YAMASHITA, Tokyo (JP)

(73) Assignee: YOKOGAWA ELECTRIC CORPORATION, Tokyo (JP)

(21) Appl. No.: 13/957,729

(22) Filed: Aug. 2, 2013

(30) Foreign Application Priority Data
Aug. 8, 2012 (JP) 2012-176081

(51) Int. Cl. G06T 11/20

(52) U.S. Cl. CPC G06T 11/206
USPC 345/440.1

(57) ABSTRACT

A waveform display apparatus displays a waveform on a display device. A scale plate is provided with graduations corresponding to values of the waveform. The scale plate is displayed in a region where the waveform is displayed, on the display device, in a state that a time axis is movable. A value of the waveform at an intersection point between one side of the scale plate and the waveform is displayed on the display device.

### CROSS-REFERENCE TO RELATED APPLICATION(S)

The present application claims the benefit of priority of Japanese Patent Application No. 2012-176081, filed on Aug. 8, 2012. The disclosures of the application are incorporated herein by reference.

### BACKGROUND

1. Technical Field

The present disclosure relates to a waveform display apparatus and, in particular, to the waveform display apparatus capable of checking values of waveforms easily.

2. Related Art

In general, an apparatus for treating waveform data such as a waveform measurement apparatus, a paperless recorder or a measurement data management apparatus also serves as a waveform display apparatus for displaying waveforms on a screen. The waveform display apparatus displays waveforms of a measurement signal on a display device contained therein or an external display device connected thereto. Users can visually recognize temporal changes of measurement data by using the waveform display apparatus.

In the waveform display apparatus, at the time of checking the value of measurement data at a certain time point, the value can be visually read with reference to scale marks being displayed. However, most of the waveform display apparatuses are each equipped with cursor function in order to reduce load of users. The cursor (also called “an index line” etc.) is a line which is orthogonal to a time axis and movable arbitrarily along the time axis, thereby displaying a value at an intersection point between the cursor and a waveform on a screen.

FIG. 13 is a block diagram illustrating an example of the configuration of the related-art waveform display apparatus equipped with the cursor function. In this example, the waveform display apparatus 400 includes a control module 410, a measurement module 420, an operation processing module 430, a display position calculation module 440, a display control module 450, a storage module 460 and a display device 470.

FIG. 14 shows an example of a screen displayed on the display device 470 of the waveform display apparatus 400. This figure shows, as an example, the display of historical trend waveforms representing past data having been stored. Pieces of the past data are respectively added with data numbers and stored in a record data storage 461 of the storage module 460.

As shown in FIG. 14A, a screen 500 of the display device 470 is divided into a waveform display region 510, a scale plate 520 and a value display region 530. In this example, waveforms of five channels and also a cursor 512 are displayed on the waveform display region 510.

On the scale plate 520 adjacent to the value display region 530, not only graduations are displayed but also current value marks 522 are respectively displayed together with corresponding channel numbers. The current value marks represent positions where the waveforms intersect with the cursor 512, respectively. On the value display region 530, the values of the positions where the waveforms respectively intersect with the cursor 512 are displayed for the respective channels.

The screen 500 is prepared by the following procedure, for example. That is, firstly, the control module 410 generates a historical trend drawing command including the designation of the data number corresponding to the display range, based on the operation of a user accepted via the operation processing module 430, and sends the command to the display position calculation module 440.

Then, the display position calculation module 440 generates, in the storage module 460, the waveform image of the waveform display region 510 based on the data corresponding to the designated data number stored in the record data storage 461 of the storage module 460. Further, the display position calculation module 440 obtains the value of data shown by the cursor 512 from the record data storage 461 of the storage module 460 based on the cursor position corresponding to data number stored in a cursor position data number storage 462 of the storage module 460 and generates, in the storage module 460, the images of the scale plate 520 and the value display region 530. The data number of the initial position of the cursor (for example, the data number of the center position) is set in the cursor position data number storage 462. Finally, the display control module 450 reads the respective images from the storage module 460 and displays the respective images on the display device 470 to thereby generate the screen 500.

A user can move the waveforms and the cursor 512 on the screen 500. The cursor 512 can be moved by touching the screen 500 or operating keys, for example. When the cursor 512 is moved according to the operation of a user, the current value marks 522 of the scale plate 520 and the display values on the value display region 530 are changed in an interlocked manner as shown in FIG. 14B.

When the operation processing module 430 accepts the cursor moving operation from a user, the operation processing module sends a cursor moving signal including the designated moving amount to the control module 410. The control module 410 obtains the data number corresponding to the moving amount and sends a redrawing command to the display position calculation module 440. Then, the display position calculation module 440 and the display control module 450 perform the processings in response to the redrawing command, thereby generating the screen 500 in which the cursor 512 is moved and both the current value marks 522 and the value display region 530 are updated.

Waveform display apparatuses each not equipped with the cursor function have also been put into practice. FIG. 15 is a block diagram illustrating an example of the configuration of the related-art waveform display apparatus not equipped with the cursor function. In this example, a waveform display apparatus 600 includes a control module 610, a measurement module 620, an operation processing module 630, a display position calculation module 640, a display control module 650, a storage module 660 and a display device 670.

FIG. 16 shows an example of the screen representing historical trend waveforms displayed on the display device 670 of the waveform display apparatus 600. As shown in FIG. 16A, the screen 700 of the display device 670 is divided into a waveform display region 710, a scale plate 720 and a value display region 730. In this example, waveforms of two channels are displayed on the waveform display region 710.

On the scale plate 720, not only graduations are displayed but also current value marks 722 are respectively displayed together with corresponding channel numbers. The current value marks represent positions where the waveforms intersect with the graduations, respectively. On the value display region 730, the values of the positions where the waveforms respectively intersect with the graduations are displayed for the respective channels.

The screen 700 is prepared by the following procedure, for example. That is, firstly, the control module 610 generates a historical trend drawing command including the designation of the data number corresponding to the display range, based on the operation of a user accepted via the operation processing module 630, and sends the command to the display position calculation module 640.

Then, the display position calculation module 640 generates, in the storage module 660, the waveform image of the waveform display region 710 and further the images of the scale plate 720 and the value display region 730, based on the data corresponding to the designated data number. Finally, the display control module 650 reads the respective images from the storage module 660 and displays the respective images on the display device 670 to thereby generate the screen 700.

A user can move the waveforms on the screen 700. The waveforms can be moved by touching the screen 700 or operating the keys, for example. When the waveforms are moved according to the operation of a user, the current value marks 722 of the scale plate 720 and the display values on the value display region 730 are changed in an interlocked manner as shown in FIG. 16B.

When the operation processing module 630 accepts the waveform moving operation from a user, the operation processing module sends a waveform moving signal including the designated moving amount to the control module 610. The control module 610 obtains the data number corresponding to the moving amount and sends a redrawing command to the display position calculation module 640. Then, the display position calculation module 640 and the display control module 650 perform the processings in response to the redrawing command, thereby generating the screen 700 in which the waveforms are moved and both the current value marks 722 and the value display region 730 are updated.

### CITATION LIST

[Patent Literature]

[Patent Literature 1] JP-A-2010-072686

By using the waveform display apparatus 400 equipped with the cursor function, the values of the waveforms at the cursor position can be read readily. However, in such a case where a plurality of waveforms are displayed in a complicated manner, the correspondence relationship between the waveforms and the values may become hard to understand intuitively depending on the positional relationship between the current value marks and the right ends of the respective waveforms. For example, as shown in FIG. 17A, in the case where a current value mark 522a representing the value of the waveform of Ch. 1 at the cursor position is close to the right end of the waveform of Ch. 2 and also a current value mark 522b representing the value of the waveform of Ch. 2 at the cursor position is close to the right end of the waveform of Ch.1, the waveform of Ch.1 and the waveform of Ch. 2 may be mixed up.

In order to prevent such the phenomenon, as shown in FIG. 17B, it is considered to modify the arrangement in a manner that each of the current value marks 522 is not interlocked with the value of the corresponding waveform at the cursor position but made correspond to the value of the corresponding waveform at the right end position. However, in this case, it becomes difficult to recognize the relationship between the waveforms and the values thereof at the cursor position.

In the case of the waveform display apparatus 600 not equipped with the cursor function, as shown in FIG. 18A, since the right ends of the waveforms respectively correspond to the current value marks 722, the correspondence relationship between the waveforms and the values thereof become clear. However, in order to check the values, since a waveform point requested to be checked (for example, a time point A in FIG. 18A) must be shifted to the right end, the waveforms are required to be drawn again. Further, in this case, as shown in FIG. 18B, since only the waveforms in the past from the waveform point (time point A) are displayed, the usability is not sufficient.

The environment where the waveform display apparatuses are used is not necessarily good such that the smooth operation is restricted or the visibility is not good due to contamination. Thus, it has been desired to intuitively recognize the correspondence relationship between the waveforms and the values thereof without degrading the operability.

### SUMMARY

Exemplary embodiments of the invention provide a waveform display apparatus which can intuitively recognize the correspondence relationship between the waveforms and the values thereof without degrading the operability.

A waveform display apparatus according to an exemplary embodiment of the invention is a waveform display apparatus for displaying a waveform on a display device, wherein the waveform display apparatus is configured to display a scale plate provided with graduations corresponding to values of the waveform in a region where the waveform is displayed, on the display device, in a state that a time axis is movable, and to display a value of the waveform at an intersection point between one side of the scale plate and the waveform on the display device.

The scale plate may be semi-transparent so that a part of the waveform overlapped with the scale plate can be seen.

The waveform display apparatus may be configured to display a mark for discriminating the waveform in a vicinity of the intersection point between the one side of the scale plate and the waveform.

In a case of displaying a plurality of waveforms, the waveform display apparatus may be configured to divide the plurality of waveforms into a plurality of groups, and to display the scale plate for each of the groups independently.

The waveform display apparatus may be configured to display two scale plates for a single waveform, and in place of the value of the waveform at the intersection point between the one side of the scale plate and the waveform, to display a calculation result based on the waveform within a range determined by the two scale plates on the display device.

The waveform display apparatus may be configured to change arrangement of the graduations in accordance with a display position of the scale plate.

The waveform display apparatus may be configured to display a time point indicated by a position of the scale plate on the scale plate.

According to the exemplary embodiment of the invention, in the waveform display apparatus, it is possible to intuitively recognize the correspondence relationship between the waveforms and the values thereof without degrading the operability.

### BRIEF DESCRIPTION OF THE DRAWINGS

FIG. 1 is a block diagram illustrating an example of the configuration of a waveform display apparatus according to the embodiment.

FIGS. 2A and 2B are views showing an example of a screen displayed on a display device of the waveform display apparatus.

FIG. 3 is a view showing an example of subjecting a scale plate to a semi-transparent processing.

FIG. 4 is a diagram showing a first modified example.

FIG. 5 is a diagram showing a second modified example.

FIG. 6 is a diagram showing a third modified example.

FIG. 7 is a diagram showing a fourth modified example.

FIG. 8 is a diagram showing a fifth modified example.

FIG. 9 is a diagram showing a sixth modified example.

FIG. 10 is a diagram showing a seventh modified example.

FIG. 11 is a diagram showing an example of waveforms displayed in the vertical direction.

FIG. 12 is a diagram showing an example of a circular display.

FIG. 13 is a block diagram illustrating an example of the configuration of the related-art waveform display apparatus equipped with the cursor function.

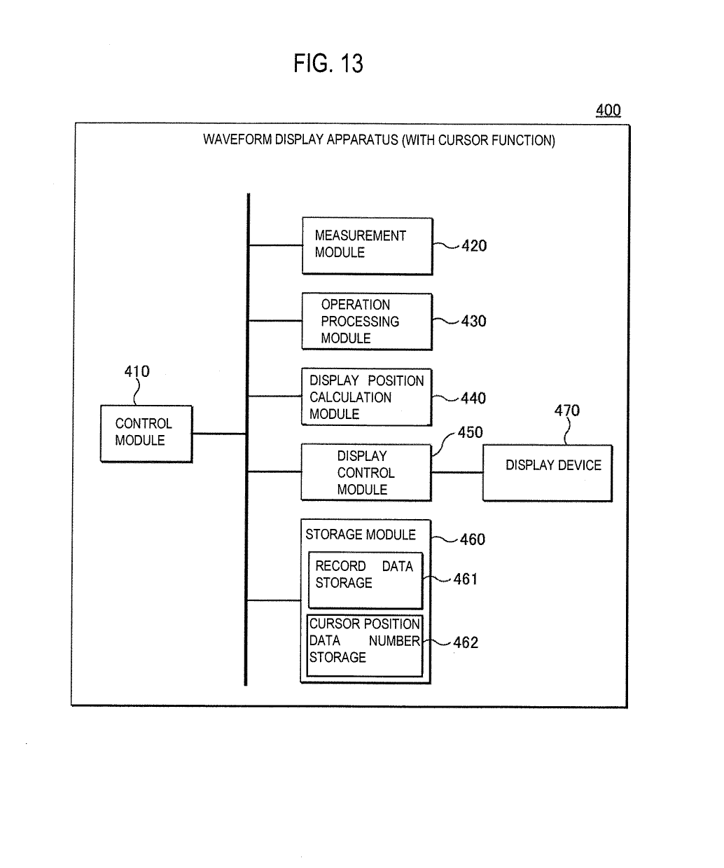

FIGS. 14A and 14B are views showing an example of a screen of the waveform display apparatus equipped with the cursor function.

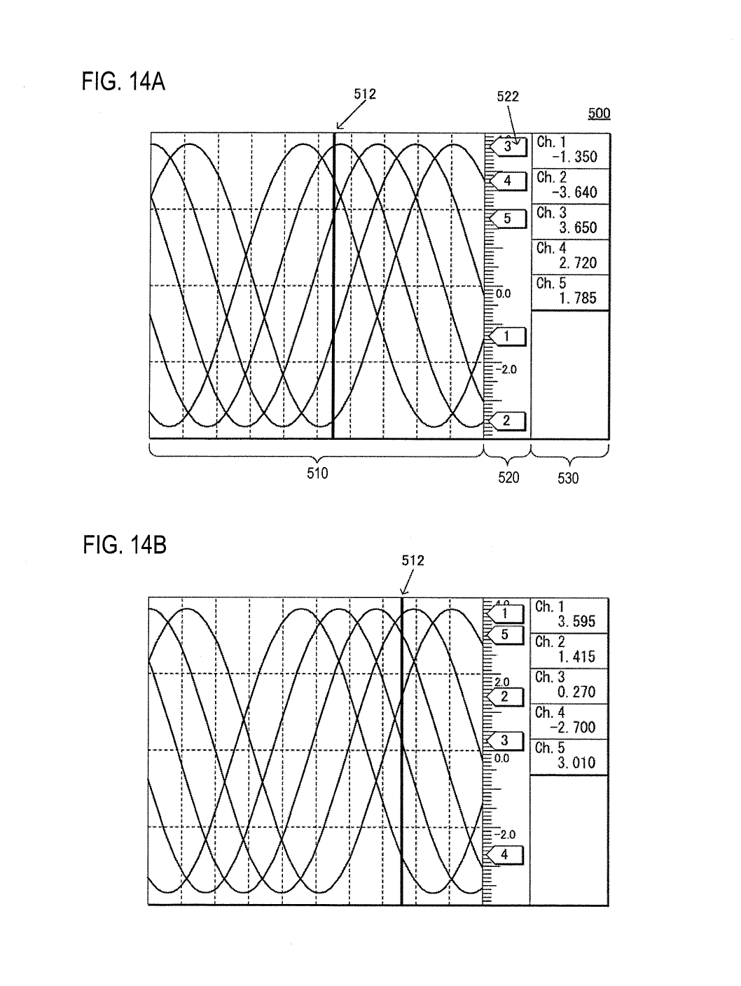

FIG. 15 is a block diagram illustrating an example of the configuration of the related-art waveform display apparatus not equipped with the cursor function.

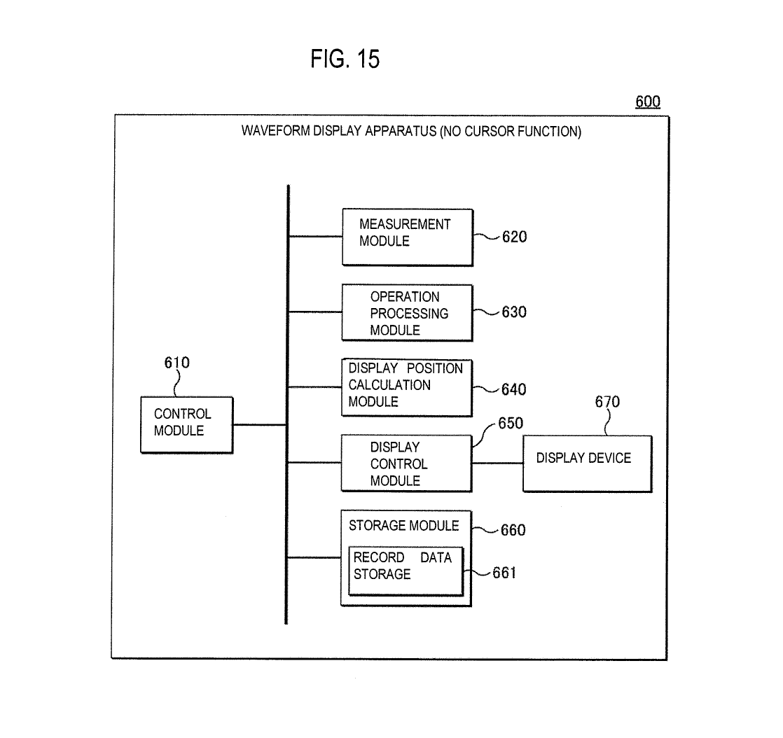

FIGS. 16A and 16B are views showing an example of a screen of the waveform display apparatus not equipped with the cursor function.

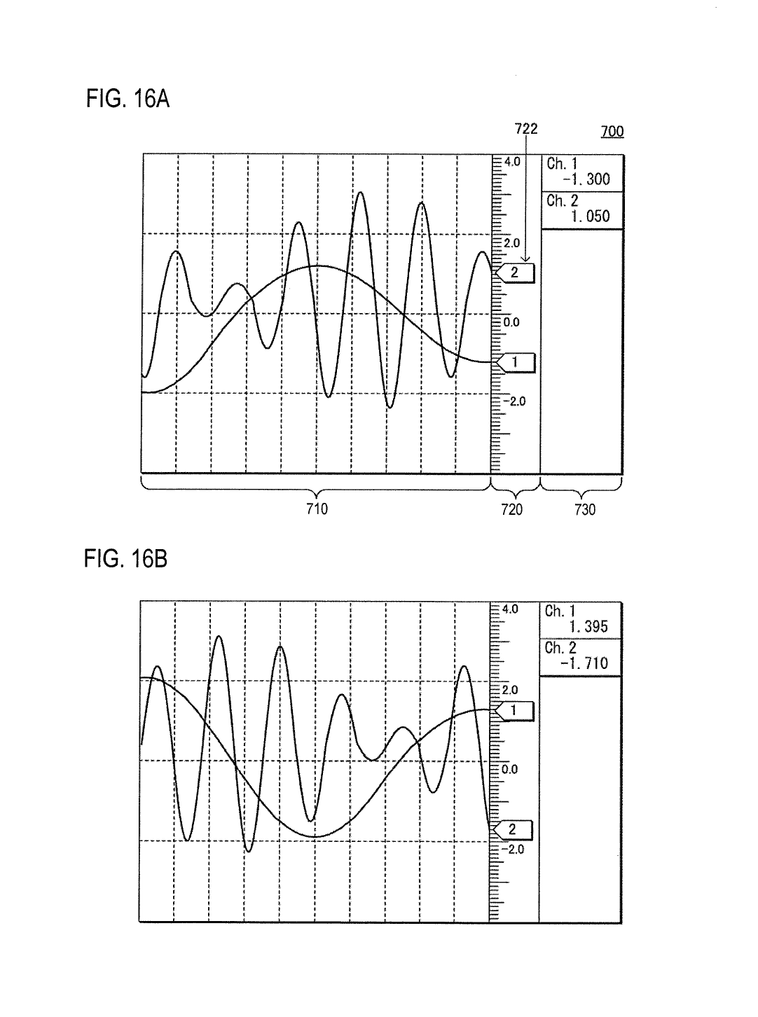

FIGS. 17A and 17B are views explaining the problem in the waveform display apparatus equipped with the cursor function.

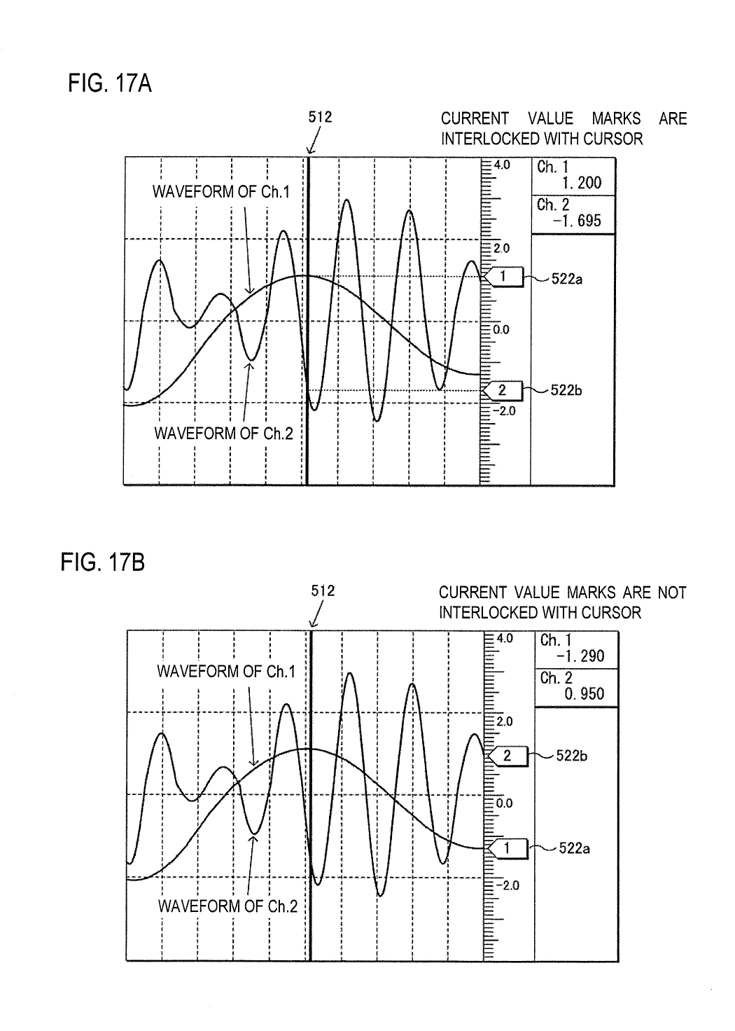

FIGS. 18A and 18B are views explaining the problem in the waveform display apparatus not equipped with the cursor function.

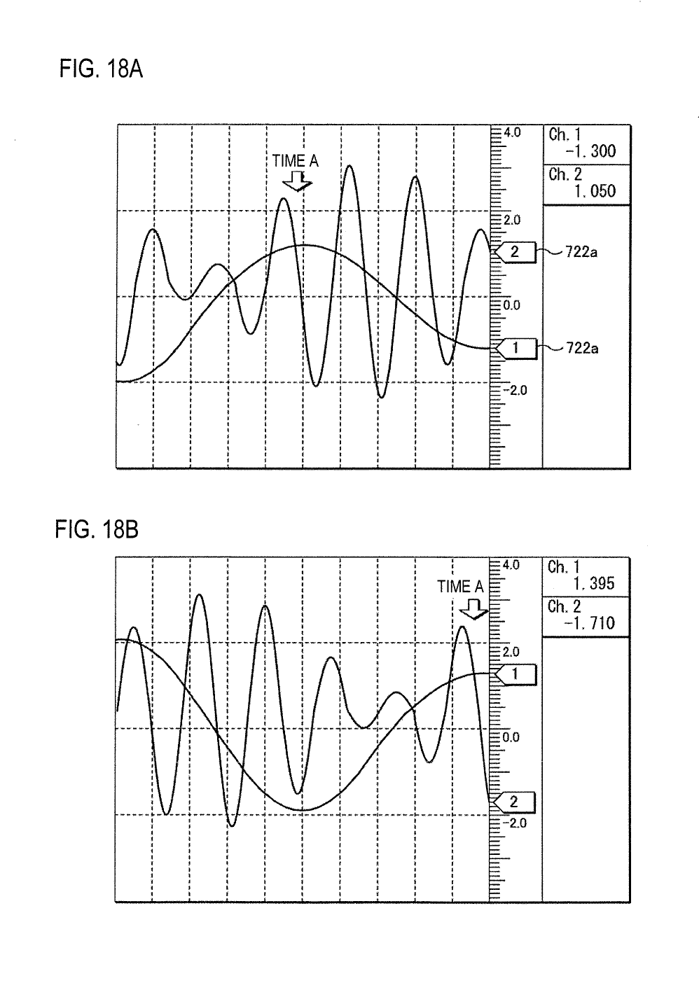

### DETAILED DESCRIPTION

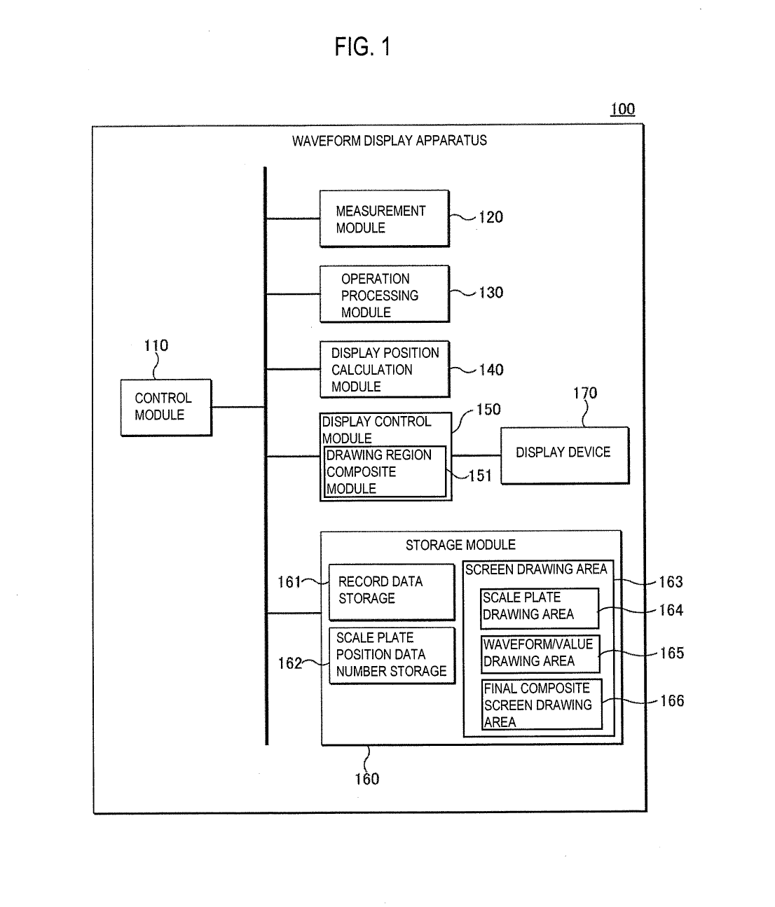

An embodiment according to the present invention will be explained with reference to accompanying drawings. FIG. 1 is a block diagram illustrating an example of the configuration of a waveform display apparatus according to the embodiment. As shown in this figure, a waveform display apparatus 100 includes a control module 110, a measurement module 120, an operation processing module 130, a display position calculation module 140, a display control module 150, a storage module 160 and a display device 170. The measurement module 120, the display device 170, and the storage module 160 may be provided outside of the waveform display apparatus or may be arranged so as to be detachable to the waveform display apparatus. The display device 170 may be equipped with a touch panel function.

The storage module 160 includes a record data storage 161, a scale plate position data number storage 162 and a screen drawing area 163. The screen drawing area 163 includes a scale plate drawing area 164, a waveform/value drawing area 165 and a final composite screen drawing area 166.

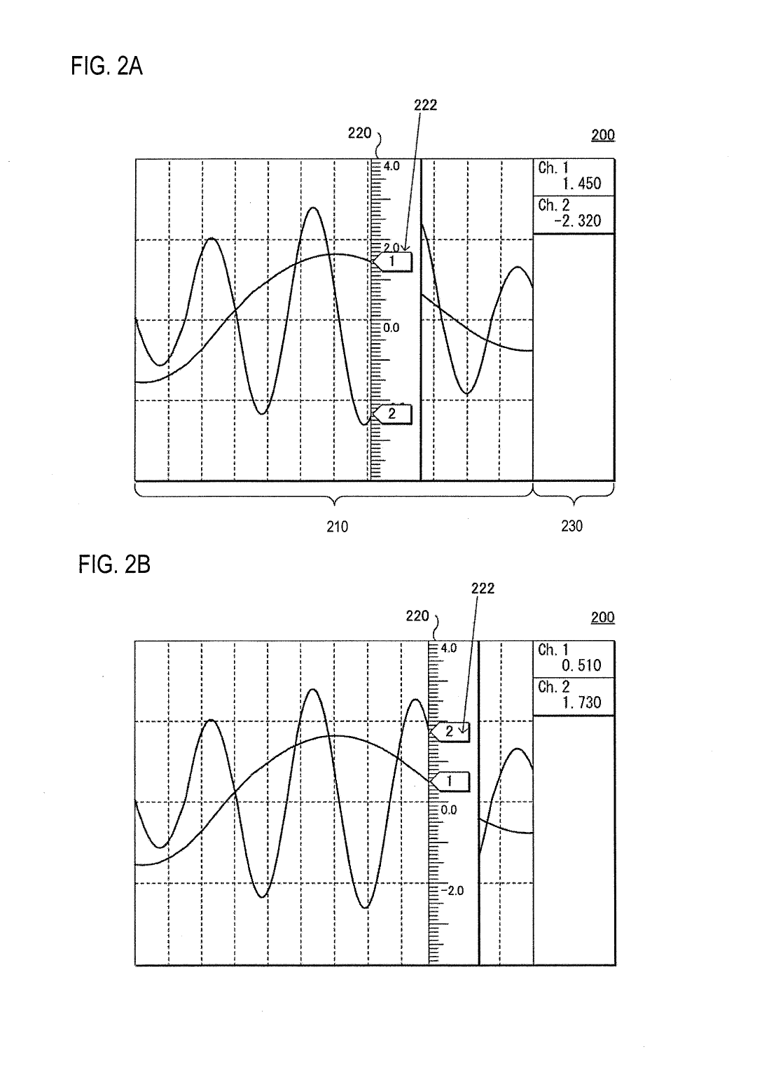

FIG. 2 shows an example of a screen displayed on the display device 170 of the waveform display apparatus 100. This figure shows, as an example, the display of historical trend waveforms. Pieces of the past data are respectively added with data numbers and stored in the record data storage 161 of the storage module 160. This invention can also be applied to the real time trend waveform display or the prediction waveform display. In this case, the waveforms of the measured data obtained by the measurement module 120 are displayed in real time or waveforms predicted from the current and past data are displayed.

As shown in FIG. 2A, a screen 200 of the display device 170 is divided into a waveform display region 210 and a value display region 230. A scale plate 220 is disposed in the waveform display region 210. The scale plate 220 can be moved arbitrarily along the time axis. On the scale plate 220, not only graduations are displayed but also current value marks 222 are respectively displayed together with corresponding channel numbers. The current value marks 222 represent positions on the scale plate where the waveforms intersect with a line on the graduation side of the scale plate 220, respectively. On the value display region 230, the values of the positions on the scale plate where the waveforms respectively intersect with the scale plate 220 are displayed for the respective channels.

The screen 200 is prepared by the following procedure, for example. That is, firstly, the control module 110 generates a historical trend drawing command including the designation of the data number corresponding to the display range, based on the operation of a user accepted via the operation processing module 130, and sends the command to the display position calculation module 140.

Then, the display position calculation module 140 generates, in the waveform/value drawing area 165 of the storage module 160, the waveform image of the waveform display region 210 based on the data corresponding to the designated data number. Further, the display position calculation module 140 obtains the value of data shown on the scale plate 220 based on the scale plate position stored in the scale plate position data number storage 162 of the storage module 160, and then generates the image of the scale plate 220 in the scale plate drawing area 164 of the storage module 160 and also generates the image of the value display region 230 in the waveform/value drawing area 165 of the storage module 160. The data number of the initial position of the scale plate 220 (for example, the right end of the waveform display region 210) is set in the scale plate position data number storage 162. Finally, the drawing region composite module 151 of the display control module 150 reads the respective images from the screen drawing area 163 of the storage module 160 and then composes the respective images in the final composite screen drawing area 166 and the display control module 150 displays the composite image on the display device 170 to thereby generate the screen 200.

A user can move the waveforms and the scale plate 220 on the screen 200. The scale plate 220 can be moved by touching the screen 200 or operating the keys, for example. When the scale plate 220 is moved according to the operation of a user, the current value marks 222 of the scale plate 220 and the display values on the value display region 230 are changed in an interlocked manner as shown in FIG. 2B.

When the operation processing module 130 accepts the scale plate moving operation from a user, the operation processing module sends a scale plate moving signal including the designated moving amount to the control module 110. The control module 110 obtains the data number corresponding to the designated moving amount and sends a redrawing command including the data number to the display position calculation module 140. Then, the display position calculation module 140 and the display control module 150 perform the processings in response to the redrawing command, thereby generating the screen 200 in which the scale plate 220 is moved and both the current value marks 222 and the value display region 230 are updated. More specifically, the display position calculation module 140 generates the image of the scale plate 220 based on the scale plate position corresponding to the data number included in the redrawing command, and the display control module 150 composes the respective images to generate the screen.

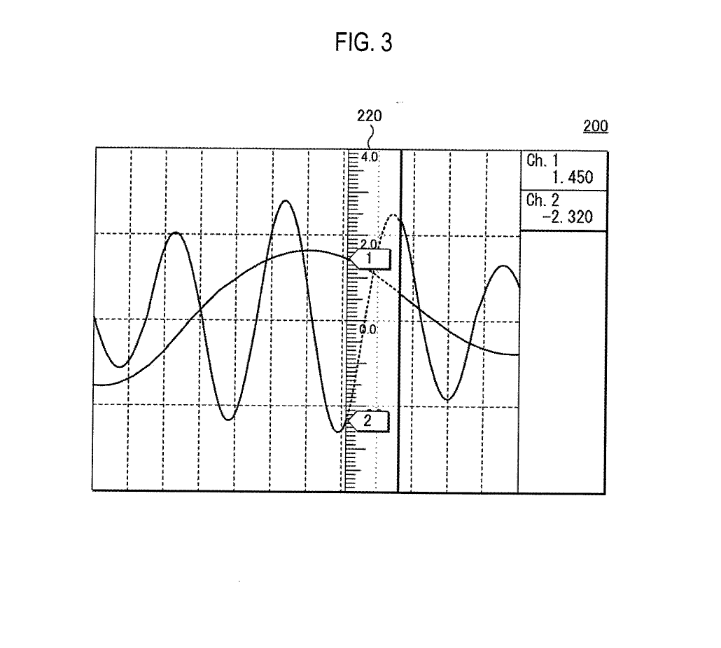

The drawing region composite module 151 desirably subjects the scale plate 220 to a semi-transparent processing at the time of the composing processing so that parts of the waveforms overlapped with the scale plate can be seen as shown in FIG. 3. As a result, the waveform display region 210 can be substantially enlarged.

In this manner, according to the waveform display apparatus 100 of this embodiment, the scale plate 220 is provided with the function such as the related-art cursor so that the scale plate can be moved to an arbitrary position with an operational feeling as if a ruler is fitted to the waveforms. In this case, the current value marks 222 directly indicate the corresponding waveforms, respectively. Thus, a user can immediately read the value of a waveform being noticed by merely moving the scale plate 220, so that the user can intuitively recognize the correspondence relationship between the waveforms and the values thereof with the simple operation.

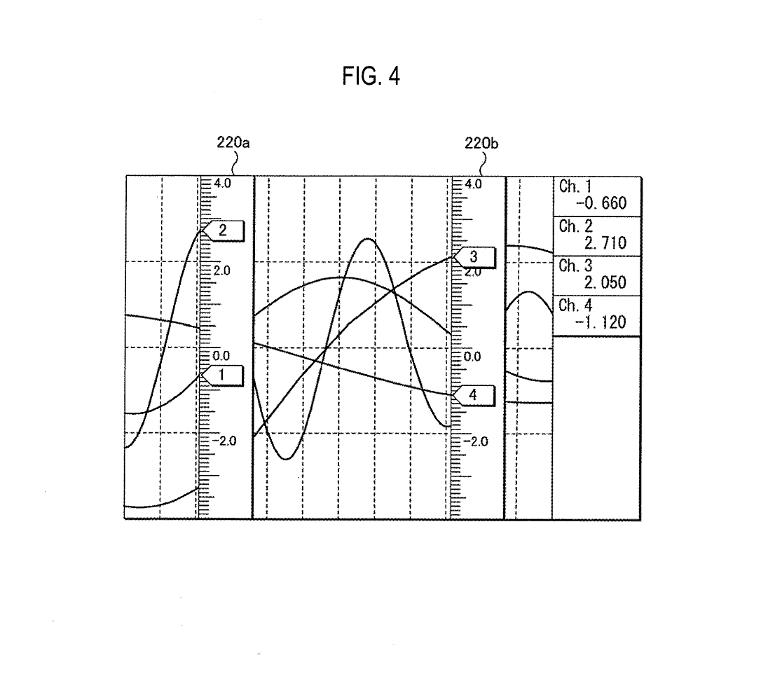

This invention is not limited to the aforesaid embodiment and can be modified in various manners. Hereinafter, modified examples of this invention will be explained. FIG. 4 is a diagram showing a first modified example. In this example, the waveforms of 4 channels are divided into two groups and two scale plates 220 are respectively allocated to the two groups. To be concrete, a scale plate 220a is allocated to the waveforms of Ch.1 and Ch.2 and a scale plate 220b is allocated to the waveforms of Ch.3 and Ch.4. In each of the scale plates 220, the current value marks are displayed in relation to the corresponding waveforms, respectively. Each of the scale plates can be moved to an arbitrary position independently.

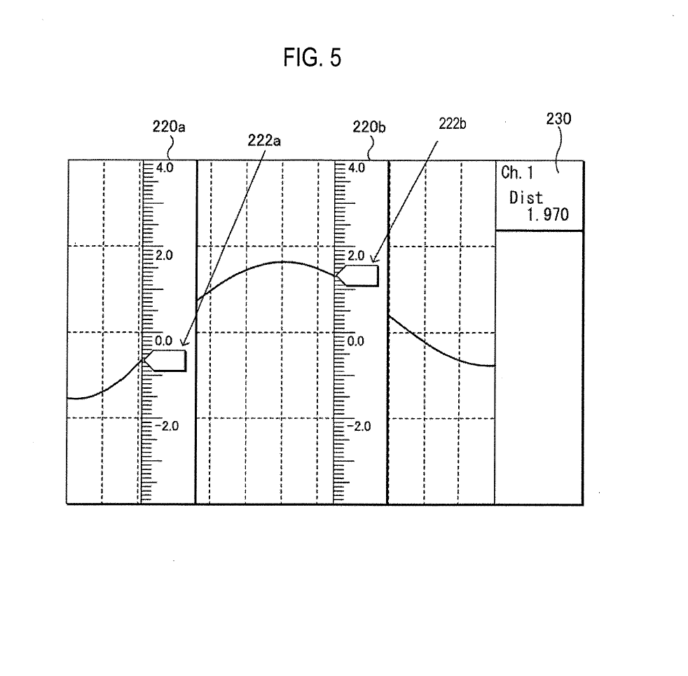

FIG. 5 is a diagram showing a second modified example. In this example, a plurality of the scale plates 220 are allocated to a single waveform. In this case, in the value display region 230, although values indicated by the respective scale plates 220 may be displayed, a calculation result of the values indicated by the scale plates 220 may be displayed as shown in this figure. That is, a difference between a value indicated by the scale plate 220a and a value indicated by the scale plate 220b is displayed in the value display region 230. The kind of the calculation is not limited to the difference and may be an inclination, integration, maximum value, minimum value etc. of a section sandwiched between the scale plates 220.

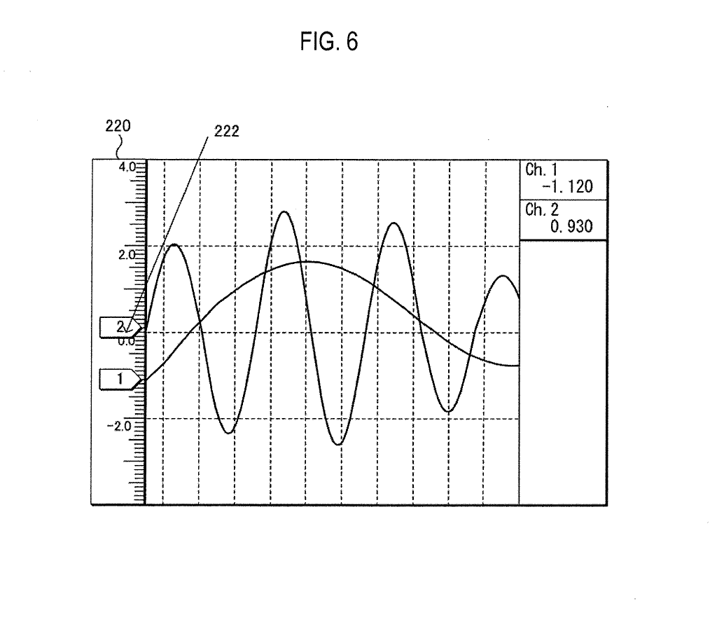

FIG. 6 is a diagram showing a third modified example. In this example, when the scale plate 220 is moved to the left end, the graduations are shifted to the right side of the scale plate 220 in order to make the graduations readily visible. In accordance with the shift of the graduations, each of the current value marks 222 is directed to the right side. The shift of the graduations may be performed automatically or manually.

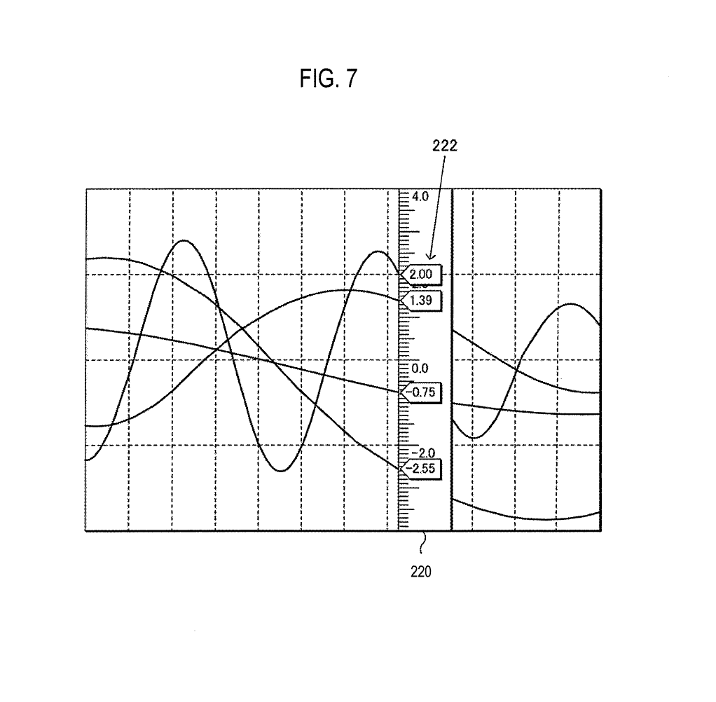

FIG. 7 is a diagram showing a fourth modified example. In this example, values of the waveforms are displayed at the corresponding current value marks 222, respectively. Thus, since the value display region 230 can be eliminated, the waveform display region 210 can be further enlarged. Also, in this case, when the scale plate 220 or the waveforms is moved, the values indicated at the current value marks 222 are changed in an interlocked manner.

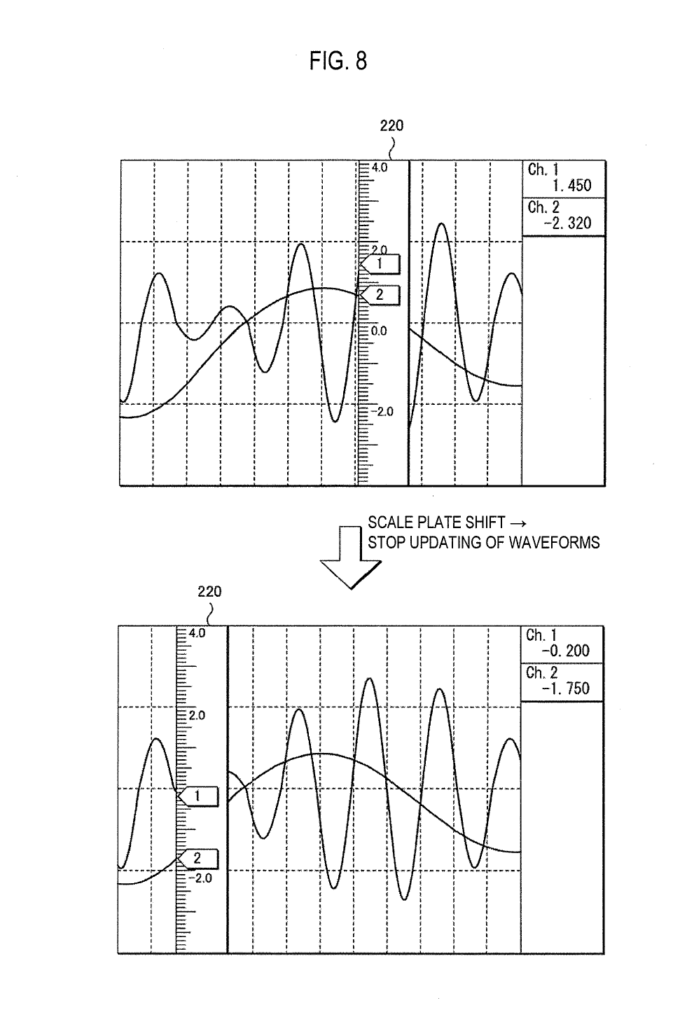

FIG. 8 is a diagram showing a fifth modified example. In this example, real time trend waveforms are displayed, and the updating of the waveforms is stopped when the scale plate 220 is moved while executing the display of the real time trend waveforms. Thus, the waveform analysis using the scale plate 220 can be performed even in the case of observing the real time waveforms. Of course, the updating of the waveforms may be continued even when the scale plate 220 is moved. In this case, the scale plate 220 may be disposed at an easily viewable position so that the change of the value can be checked. It is desirable that a user can set as to whether or not the updating of the waveforms is performed in the case where the scale plate 220 is moved while executing the real time trend waveform display.

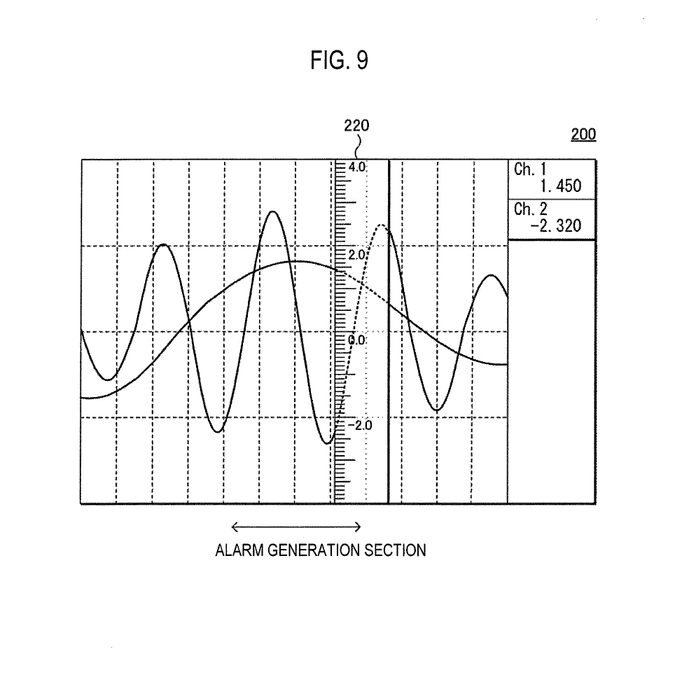

FIG. 9 is a diagram showing a sixth modified example. In this example, none of the current value marks are displayed on the scale plate 220. It is desirable that a user can instruct the display/non-display of the current value marks. For example, in a section such as an alarm generation section where a user wants to observe the waveforms mainly, since an alarm mark representing an alarm setting value and the waveforms etc. are not hidden by the current value marks, the waveforms can be observed easily.

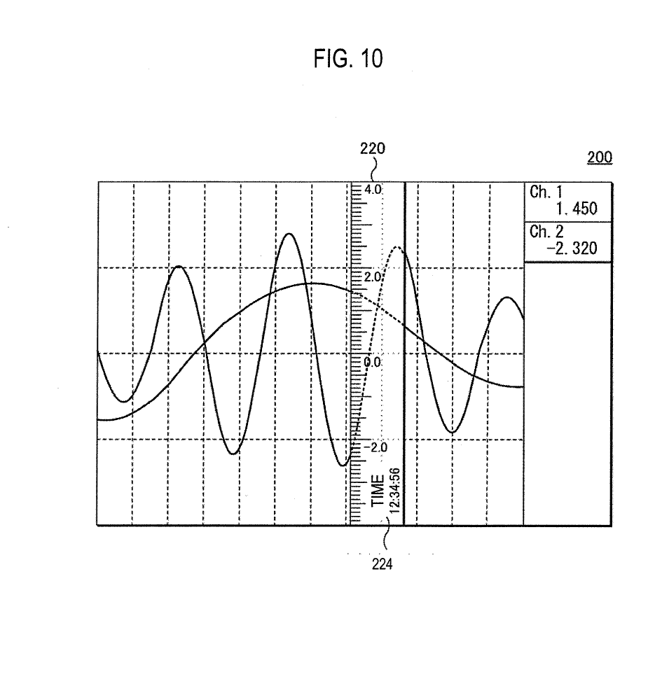

FIG. 10 is a diagram showing a seventh modified example. In this example, a time display region 224 is provided on the scale plate 220 so as to display a time point indicated by the position of the scale plate 220. According to this example, since a time point is displayed not on the other region of the screen but on the scale plate 220, a user can easily check, without moving the eye, an alarm generation time and a time point at which a predetermined value is measured. In place of the time point, an elapsed time, data number etc. may be displayed.

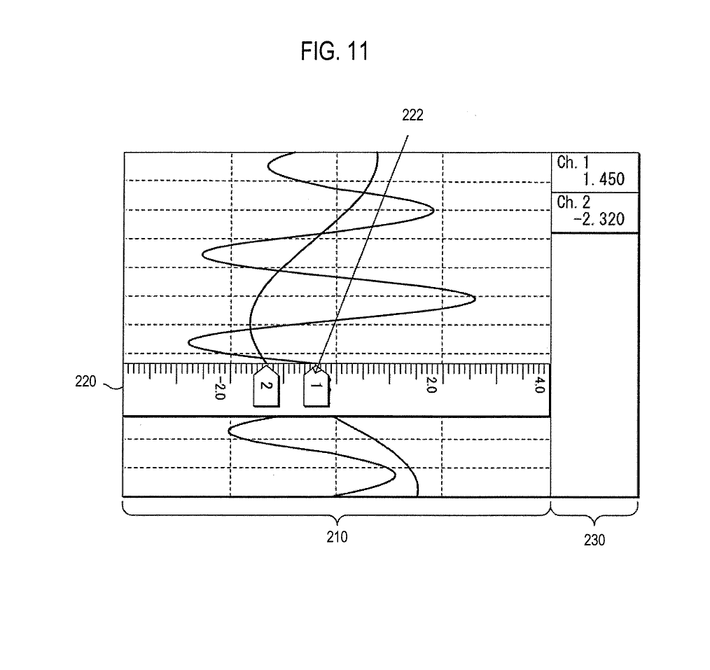

FIG. 11 is a diagram showing an example where this invention is applied to a case that waveforms are displayed in the vertical direction. Also, in this example, the scale plate 220 is disposed so as to be orthogonal to the time axis, and the current value marks 222 are displayed at positions where the scale plate 220 crosses with the waveforms, respectively.

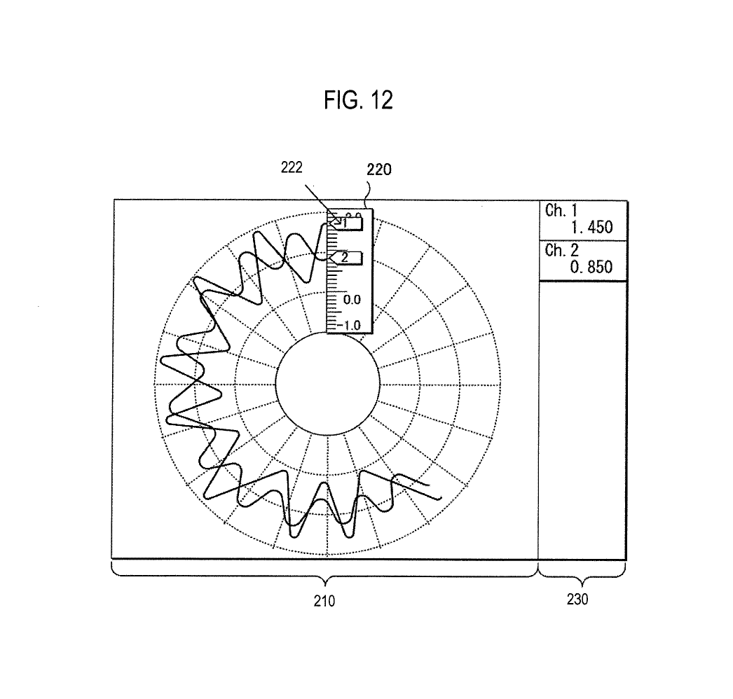

FIG. 12 is a diagram showing an example where this invention is applied to a circular display. In this example, the scale plate 220 is disposed along the radial direction of a circle within which waveforms are displayed, and the current value marks 222 are displayed at positions where the scale plate 220 crosses with the waveforms, respectively. The scale plate 220 is movable around a central axis, that is, the center of the circle within which waveforms are displayed.

What is claimed is:

1. A waveform display apparatus for displaying a waveform on a display device, wherein
the waveform display apparatus is configured to display a scale plate provided with graduations corresponding to values of the waveform in a region where the waveform is displayed, on the display device, in a state that a time axis is movable, and to display a value of the waveform at an intersection point between one side of the scale plate and the waveform on the display device.

2. The waveform display apparatus according to claim 1, wherein the scale plate is semi-transparent so that a part of the waveform overlapped with the scale plate can be seen.

3. The waveform display apparatus according to claim 1, wherein the waveform display apparatus is configured to display a mark for discriminating the waveform in a vicinity of the intersection point between the one side of the scale plate and the waveform.

4. The waveform display apparatus according to claim 1, wherein in a case of displaying a plurality of waveforms, the waveform display apparatus is configured to divide the plurality of waveforms into a plurality of groups, and to display the scale plate for each of the groups independently.

5. The waveform display apparatus according to claim 1, wherein the waveform display apparatus is configured to display two scale plates for a single waveform, and to display a calculation result based on the waveform within a range determined by the two scale plates on the display device in place of the value of the waveform at the intersection point between the one side of the scale plate and the waveform.

6. The waveform display apparatus according to claim 1, wherein the waveform display apparatus is configured to change arrangement of the graduations in accordance with a display position of the scale plate.

7. The waveform display apparatus according to claim 1, wherein the waveform display apparatus is configured to display a time point indicated by a position of the scale plate on the scale plate.

8. The waveform display apparatus according to claim 1, further comprising:
a display position calculation module configured to generate a waveform image based on measurement data, and to generate an image of the scale plate based on a position of the scale plate;
a display control module configured to compose the waveform image and the image of the scale plate so that the scale plate is displayed in the region where the waveform is displayed.
